(19) United States
(12) Patent Application Publication
(10) Pub. No.: US 2009/0154712 A1
(43) Pub. Date: Jun. 18, 2009

(54) APPARATUS AND METHOD OF OUTPUTTING SOUND INFORMATION

(75) Inventors: Keiko Morii, Kanagawa (JP); Tomohiro Konuma, Saitama (JP); Yumi Wakita, Nara (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 11/568,219

(22) PCT Filed: Apr. 19, 2005
(86) PCT No.: PCT/JP2005/007423

§ 371 Date: Oct. 23, 2006

(30) Foreign Application Priority Data
Apr. 21, 2004 (JP) 2004-125235
Apr. 11, 2005 (JP) 2005-113239

(51) Int. Cl. H04R 5/00

(52) U.S. Cl. 381/1

(57) ABSTRACT

An azimuth and distance calculator calculates the relative direction and distance to the next intersection to be guided, based on information on the intersection supplied from storage for received information on an object to be guided and information on the moving histories of a user. Then, the calculator converts the relative direction into a horizontal angle and the distance to an elevation angle, and passes the angles to a stereophony generator. The stereophony generator creates output sound information having a sound image localized outside of a headphone and outputs the information to the headphone. In this manner, the user can accurately understand the distance to the object.

### TECHNICAL FIELD

The present invention relates to a sound information output apparatus and method that output sound information on an object to be guided.

### BACKGROUND ART

One of conventional apparatuses and methods of outputting sound information provides guiding sound from the direction of a destination and controls the sound volume according to the distance thereto.

In the conventional art, because guiding sound controlled according to target information is supplied from a plurality of speakers separately disposed in a vehicle cabin, in response to left or right turn at the target intersection, the user can hear the guiding sound from the direction of the destination with respect to the current position of the vehicle. Also in the conventional art, gradually increasing the volume of the guiding sound as the vehicle is approaching to the target intersection allows the user to recognize a sense of distance (Japanese Patent Unexamined Publication No. 11-30525, for example).

However, in the conventional structure, only the sound volume shows the distance to the user. This sound volume is not information of which absolute quantity can be understood by the user. For this reason, the conventional art does not necessarily give the distance to the user in a comprehensive form.

### SUMMARY OF THE INVENTION

According to one aspect of the present invention, there is provided a sound information output apparatus including: an azimuth and distance information determination part for determining information on an azimuth and distance to an object to be guided to a user, based on information on a route to the position of the object to be guided, and a moving direction calculated from information on the position of the user; a vertical position determination part for determining a vertical position of a sound source, based on information on the distance determined by the azimuth and distance information determination part; and a stereophony output part for outputting a sound signal so that the sound source is virtually disposed in a place in which the vertical position thereof is determined by the vertical position determination part and the horizontal position thereof is in front of the user. With this structure, the user can accurately understand the distance to the object to be guided through the sound information.

According to another aspect of the present invention, there is provided a sound information output apparatus in which the horizontal position of the sound source is not limited to the front of the user, and is determined by a horizontal position determination part for determining the horizontal position of the sound source based on the azimuth information determined by the azimuth and distance information determination part. With this structure, the user can accurately understand the distance to the object through the sound information.

According to another aspect of the present invention, there is provided a sound information output apparatus in which the horizontal position of the sound source is not limited to the front of the user, and is determined by a horizontal position determination part that divides the azimuth into more than one section, replaces the azimuth information determined by the azimuth and distance determination part with a typical value of each section azimuth information belongs to, and determines the horizontal position of the sound source based on the typical values.

According to still another aspect of the present invention, there is provided a sound information output apparatus in which, when the vertical position determination part uses the distance information to determine a vertical angle, the determination part distributes the distance from zero to a certain value from a horizontal to upper vertical angle, and sets the vertical angle to a horizontal or proximity to horizontal at distances farther than a predetermined distance.

This structure allows the distance information to be converted into a vertical angle, and thus the user can easily understand the distance information.

According to yet another aspect of the present invention, there is provided a sound information output apparatus in which the predetermined distance is determined by using at least one of a moving speed of the user, information on a type of the road the user is running, a shape of the road the user has been running, and a value set by the user.

This structure allows the distance information to be converted into a vertical angle according to the use conditions of the sound information output apparatus, and thus the user to easily understand the distance information.

According to still another aspect of the present invention, there is provided a sound information output apparatus including: a speech data input part for receiving speech data; and an extractor of information on an object to be guided for determining the object to be guided, based on the speech data fed into the speech data input part, and extracting information on the route to the object. With this structure, the user can determine the object to be guided and extract the information thereon even when the user cannot use the user's hand.

According to yet another aspect of the present invention, there is provided a sound information output apparatus including: a speech data input part for receiving speech data; a transmitter for transmitting a sound related data fed into the speech data input part to another apparatus; and a receiver for receiving information on the route to the object to be guided that has been extracted from another apparatus, based on the sound related data transmitted by the sound data transmitter. With this structure, the user can receive information on the object to be guided that has been extracted by another apparatus even when the user cannot use the user's hand.

According to still another aspect of the present invention, there is provided a sound information output apparatus including: a noise suppressor for suppressing the influence of a predetermined noise among those fed into the speech data input part together with the speech data. This structure allows the user to obtain information on the object to be guided, based on accurate sound data even from the sound data including noises.

According to yet another aspect of the present invention, there is provided a sound information output apparatus in which the noise suppressor performs spectral subtraction using predetermined acoustic models or band control based on acoustic frequency bands. This structure can suppress noises caused by predetermined acoustic models or acoustic frequency bands, such as whizzing or road noises of running vehicles.

According to an aspect of the present invention, there is provided a sound information outputting method of the present invention including: determining information on an azimuth and distance to an object to be guided to a user, based on information on a route to the object, and a moving direction calculated from information on the position of the user; determining a vertical position of a sound source based on the information on the distance determined by the azimuth and distance determining step; and outputting stereophony to output sound signals so that the sound source is virtually disposed in a place in which the horizontal position thereof is in front of the user and the vertical position thereof is as determined by the vertical position determining step. This method allows the user to instinctively understand the distance to the object to be guided through the sound information.

According to another aspect of the present invention, there is provided a sound information outputting method, in which the horizontal position of the sound source is not limited to the front of the user, and is further determined by the azimuth information determined by the azimuth and distance information determining step. This method allows the user to instinctively understand the azimuth and distance to the object to be guided through the sound information.

### BRIEF DESCRIPTION OF THE DRAWINGS

FIG. 1 is a functional block diagram illustrating a structure of a navigation system in accordance with a first exemplary embodiment of the present invention.

FIG. 2 is a table showing information on current positions recorded in storage for received information on an object to be guided of a navigator in accordance with the first exemplary embodiment.

FIG. 3A is a diagram showing a conversion table included in an azimuth and distance calculator of the navigator in accordance with the first exemplary embodiment.

FIG. 3B is a diagram showing a conversion table included in the azimuth and distance calculator of the navigator in accordance with the first exemplary embodiment.

FIG. 4 is a flowchart showing operation of the navigator in accordance with the first exemplary embodiment.

FIG. 5 is a table showing a relation between a moving speed, a type of roads, and fixed distance r included in the azimuth and distance calculator of the navigator in accordance with the first exemplary embodiment.

FIG. 6 is a functional block diagram illustrating a structure of a navigation system in accordance with a second exemplary embodiment of the present invention.

FIG. 7 is a flowchart showing operation of a navigator in accordance with the second exemplary embodiment.

### REFERENCE MARKS IN THE DRAWINGS

11 User
101 Headphone
102, 601 Microphone
103 Speech processor
104 Server
105 Position information detector
106 Storage for received information on an object to be guided
107 Azimuth and distance calculator
108 Stereophony generator
110, 610 Navigator
111 Transmitter
112 Receiver
602 Input noise suppressor
603 Acoustic model
604 Sound volume calculator

### DETAILED DESCRIPTION OF PREFERRED EMBODIMENTS

Exemplary embodiments of the present invention are described hereinafter, with reference to the accompanying drawings.

### First Exemplary Embodiment

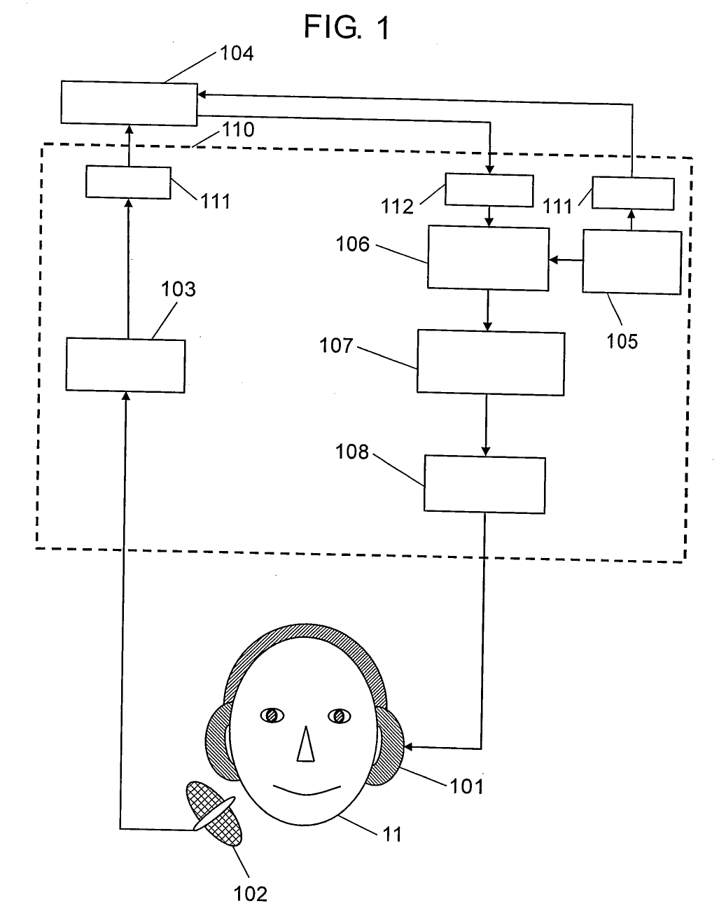

FIG. 1 is a block diagram illustrating a structure of a navigation system in accordance with the first exemplary embodiment of the present invention. This navigation system includes navigator 110, i.e. a sound information output apparatus of the present invention, server 104, microphone 102, and headphone 101. Server 104 searches a route to an object to be guided that has been requested by navigator 110, and gives navigator 110 route information showing the route.

Headphone 101 is mounted on the body of user 11. The headphone is capable of outputting dual-system stereo sound. Headphone 101 is capable of virtually localizing a sound source at a given position in a three-dimensional space using this dual-system stereo sound. In this exemplary embodiment, it is assumed that the user is driving a motorbike, and headphone 101 is installed under equipment for protecting the user's head, such as a helmet.

Microphone 102 can be mounted on the body of user 11 to capture sound data generated by user 11. Further including a noise canceling function, this microphone 102 is capable of suppressing surrounding noises by the level detection and filtering disclosed in Japanese Patent Unexamined Publication No. 2002-379544. Microphone 102 corresponds to a speech data input part of the present invention.

Next, the structure and operation of navigator 110 are described. With reference to FIG. 1, navigator 110 includes: speech processor 103 for processing sound data from microphone 102; transmitter 111 for transmitting the sound data from speech processor 103; receiver 112 for receiving route information from server 104, storage for received information on an object to be guided 106 for storing the received route information; position information detector 105 for detecting the current position of navigator 110; azimuth and distance calculator 107 for calculating azimuth data and distance data based on the route information stored in storage for received information on an object to be guided 106 and the current position information detected by position information detector 105; and stereophony generator 108 for generating a stereophony based on the azimuth data and distance data calculated by azimuth and distance calculator 107, and feeding the stereophony to headphone 101. Azimuth and distance calculator 107 corresponds to an azimuth and distance information determination part, horizontal position determination part, and vertical position determination part of the present invention. The stereophony generator corresponds to a stereophony output part of the present invention.

The operation of navigator 110 structured as above is described hereinafter with reference to the accompanying drawings.

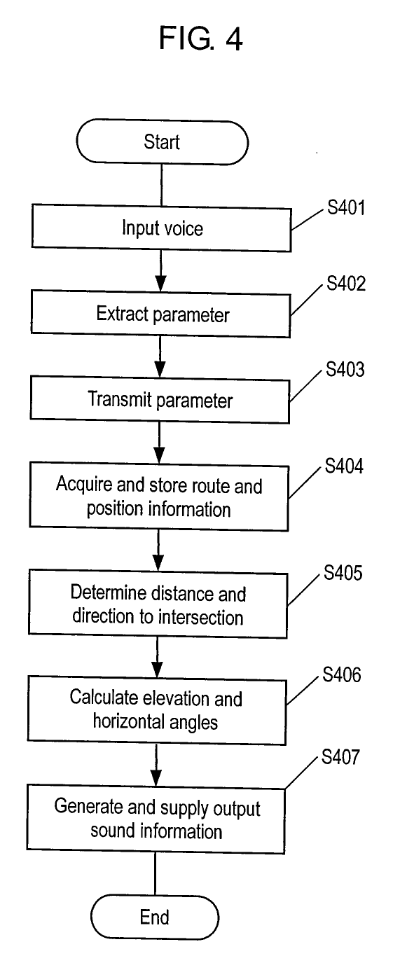

FIG. 4 is a flowchart showing the operation of the navigator, i.e. a sound information output apparatus of the present invention.

With reference to FIG. 4, when user 11 generates a speech “Set X Zoo as a destination.” to microphone 102, the sound data supplied from microphone 102 is fed into speech processor 103 (step S401). Speech processor 103 converts the supplied sound data into digital signals. Then, parameters to be used for speech recognition, such as a Mel Filter Bank Cepstrum coefficient (MFCC) and LPC Cepstrum coefficient (LPC), are extracted from speech signals. In this exemplary embodiment, LPCs are extracted (step S402).

Next, speech processor 103 transmits the obtained parameters to server 104, via transmitter 111 (step S403). Server 104 performs speech recognition on the received parameters, develops information that the destination is “X Zoo”, and obtains information on the position of “X Zoo” based on a map database included in server 104.

On the other hand, position information detector 105 detects information on the current position every minute, for example, using a global positioning system (GPS), transmits the information to server 104 via transmitter 111, and also outputs the position information to storage for received information on an object to be guided 106. With this structure, server 104 is capable of searching an optimum route from the position of navigator 110 used by user 11 to the destination, “X Zoo”.

The route information created by the search results includes information on a plurality of branched intersections and the direction from each intersection, and a date of creation of the route information, of which total capacity is within approx. 100 megabytes. Server 104 transmits the obtained route information to navigator 110 via communication lines. Storage for received information on an object to be guided 106 stores this route information that has been received via receiver 112 (step S404).

Information storage media (not shown) of this exemplary embodiment include a flash memory, static random access memory (SRAM), and hard disk drive (HDD). However, these information storage media have limited capacities. For this reason, when new route information is received, 200 megabytes of old route information stored, for example, is sequentially deleted from the oldest piece until a predetermined free space is available.

Further, storage for received information on an object to be guided 106 holds moving history information of user 11 by always holding 60 pieces of information on the positions of navigator 110 corresponding to the positions of user 11, for example, from the newest piece of the information supplied from position information detector 105 (step S404).

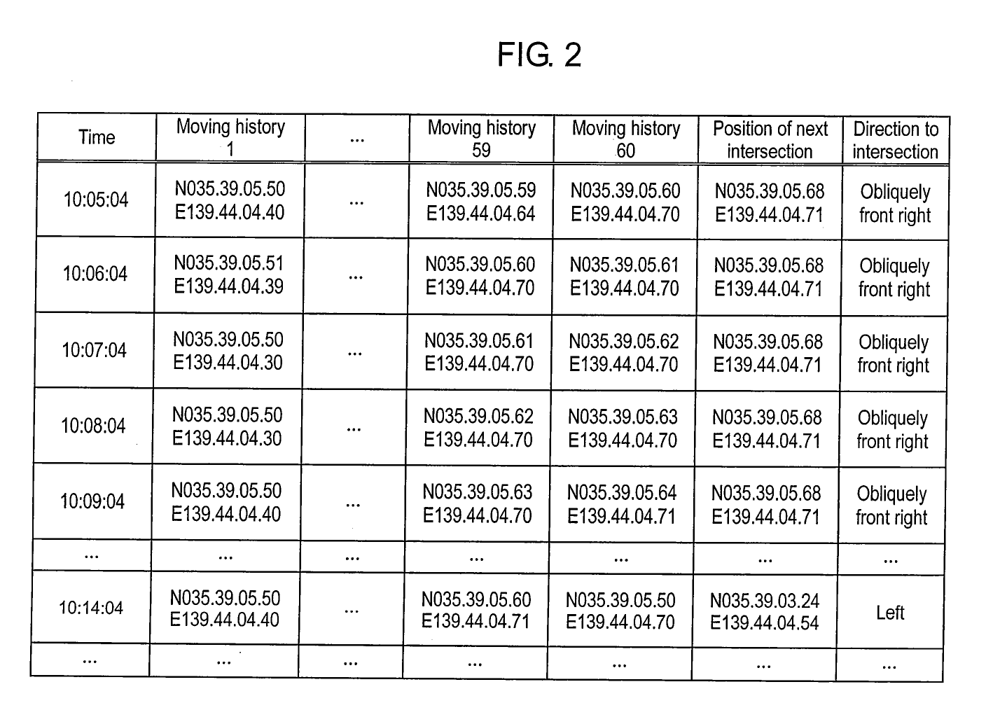

Then, storage for received information on an object to be guided 106 transmits information on the next intersection to be guided, from the information on moving histories and routes of user 11 held therein, to azimuth and distance calculator 107 every minute, for example. The information to be transmitted is a series of data shown in a history table of FIG. 2, for example.

Next, after having received information on the intersection to be guided and information on the moving histories of user 11, azimuth and distance calculator 107 determines a direction in which user 11 is currently moving, with reference to the moving histories of user 11. At the same time of determining “the direction in which user 11 is currently moving”, azimuth and distance calculator 107 sets the latest information on the moving histories as the current position of user 11, and next determines “the direction to the next intersection to be guided”. Then, azimuth and distance calculator 107 calculates a relative direction to the next intersection to be guided with respect to the direction in which user 11 is currently moving, using “the direction in which user 11 is currently moving” and “the direction to the next intersection to be guided” from the current position of user 11 (step S405).

Thereafter, azimuth and distance calculator 107 converts the distance from the current position of user 11 to the next intersection to be guided into an elevation angle, the relative direction into a horizontal angle, and passes sound source information made of the obtained elevation angle and horizontal angle to stereophony generator 108 (step S406). As for the elevation angles, the horizontal in an upright position of the user is set to standard 0 degree. Any angle larger than the horizontal is defined as an elevation angle. As for horizontal angles, the angle formed when the user faces to the front is defined as standard 0 degree. While the user is moving by motorbike, for example, the head can slightly tilt, but no considerable variations are made because the user takes almost all the actions looking at the front. Thus, the information is supplied on the assumption that headphone 101 is always placed in a position in which the user wears headphone 101 and looks at the front sitting on the seat.

Next, stereophony generator 108 generates output sound information having a virtual sound image outside of the headphone according to techniques disclosed in Japanese Patent Unexamined Publication No. H09-182199 and Collected Papers 2-5-3 of 2003 Autumn Meeting of Acoustical Society of Japan, for example. One of the techniques is determining the position of a virtual sound source, and convoluting simulated space transfer characteristics from the virtual sound source to right and left ears separately through right and left channels, respectively. Then, after having converted the output sound information into analog sound signals, stereophony generator 108 outputs the signals to headphone 101 (step S407). As for setting a sound source in generation of a stereophony, as disclosed in Collected Papers 2-5-3 of 2003 Autumn Meeting of Acoustical Society of Japan, it is known that expected characteristics, i.e. transfer characteristics when the sound source is in an expected position, have higher reproducibility when the distance between the center position of the head and the virtual sound source is not so close. In this exemplary embodiment, according to the information disclosed in Collected Papers 2-5-3 of 2003 Autumn Meeting of Acoustical Society of Japan, the distance from the center position of the head to the virtual sound source is set to 6 m.

In this exemplary embodiment, the expression used when azimuth and distance calculator 107 converts a distance into an elevation angle is represented by the following expression 1.

$$θ = \frac{π}{2} - \frac{dist}{r} \qquad ( Mathematical Expression 1 )$$

where, θ is an angle in radian, dist shows a distance from the current position to the object to be guided, r is a constant showing a fixed distance. When dist/r is larger than π/2, π/2 is used, and θ takes a positive value only. The horizontal when the user is upright and facing to the front is set to standard 0 degree, and the upper vertical is set to π/2.

In this exemplary embodiment, used as constant r in expression 1 is a fixed value of 5 km. Using such a fixed value, the user can obtain information on a distance to the next intersection, using the elevation angle with respect to the virtual sound source. In other words, at a distance within 0.2 km, the user hears the speech from substantially a vertical direction, and can understand that the user should prepare for turning. At a distance of 5 km or farther, the user hear the speech from substantially a horizontal direction, and can instinctively understand that there is an extra distance to the next intersection.

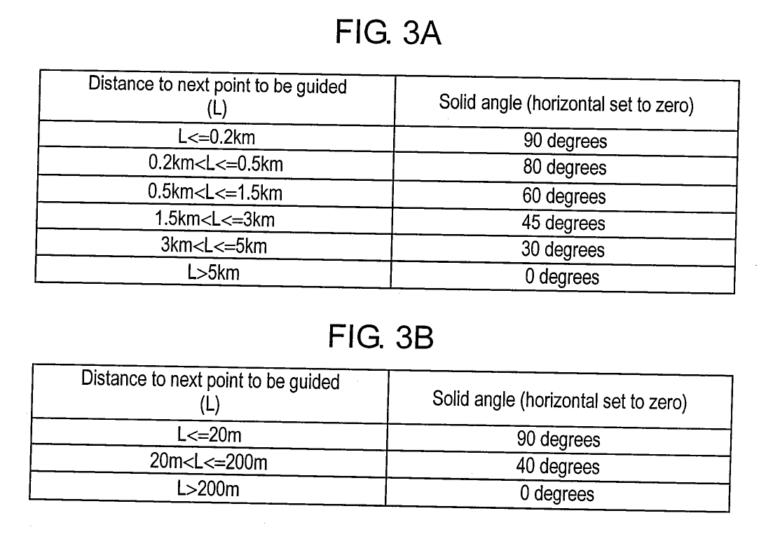

In this exemplary embodiment, expression 1 is used as an expression for converting a distance into an elevation angle. However, using a logarithm expression as shown in the following expression 2 can also provide the similar advantages.

$$θ = \frac{π}{2} - ln ( a \cdot \frac{dist}{r} + 1 ) \qquad ( Mathematical Expression 2 )$$

where, θ is an angle in radian, a is a constant to be multiplied by a distance, i.e. 2 in this embodiment, dist shows a distance from the current position to the object to be guided, and r is a constant showing a fixed distance. When {ln(a·dist/r+1)} is larger than π/2, π/2 is used, and θ takes a positive value only. Thus, in comparison with expression 1, expression 2 has an advantage of allowing the user to more easily recognize a distance to the object to be guided at a distance of 5 km or farther. A distance can be converted into an elevation angle by using not only mathematical expressions, such as expressions 1 and 2, but also a conversion table as shown in FIG. 3A. This process can also provide the similar advantages.

Incidentally, “Auditory perception and sound, New Edition” under the editorship of Tanetoshi Miura published by the Institute of Electronics Information and Communication Engineers discloses that human perception of a sound source is more sensitive to the right and left positions, and is not so sensitive to the upper and lower positions.

Therefore, whether to choose expressions 1 or 2 is not so important. Setting constant r in expressions 1 and 2 according to the moving speed of the user is more important. For example, when the user is moving by a motorbike, using a value ranging from several kilometers to several tens kilometers is appropriate. If a value around several tens meters is used, the elevation angles at extremely close distances are saturated with 0 degree, and thus the user cannot instinctively recognize the distance to the object to be guided.

When a conversion table as shown in FIG. 3A is set, as similar to the above case, it is desirable to divide the distances into levels shown in FIG. 3A (six steps) or more roughly, according to moving speeds. Alternatively, when the user is moving on foot, it is necessary to set constant r in expressions 1 and 2 to a numerical value ranging from several tens meters to approx. one hundred meters. When the conversion table is used, it is desirable to divide the range into three steps as shown in FIG. 3B.

As shown above, the present invention allows the user to recognize changes in the distance from the current position to the object to be guided, as changes in the elevation angle of the guiding sound with respect to the virtual sound source. Thus, the user can instinctively understand the distance to the object to be guided.

In this exemplary embodiment, azimuth and distance calculator 107 converts a relative direction from the current position of user 11 to the next intersection to be guided into a horizontal angle, to generate information on the sound source; however, it is not essential. In other words, also by fixing the horizontal position to the front or its vicinity of user 11, and converting the distance from the current position of user 11 to the next intersection to be guided into an elevation angle, user 11 can instinctively understand the distance to the object to be guided.

Further, in this exemplary embodiment, sound signals from stereophony generator 108 are supplied from headphone 101 mounted on the body of user 11. However, any form capable of outputting sound to user 11 can be used. For example, when used for a bicycle or motorbike, the headphone can be installed on equipment for protecting the user's head, such as a helmet. Alternatively, disposing a plurality of speakers so that a virtual sound source is generated in a given position in a three-dimensional space in a vehicle and setting the center position or orientation of the head of the driver looking at the front to standards can provide a elevation angle and horizontal angle with respect to the object to be guided as output sound information.

In this exemplary embodiment, microphone 102 is mounted on the body of user 11. However, the present invention is not limited to this example, and any form capable of capturing speech generated by user 11 can be used. In other words, when used for a bicycle or motorbike, the microphone can be installed on equipment for protecting the user's head, such as a helmet, and can be made into a form installed below the ear of user 11 to capture the speech generated by the user through bone vibrations.

In this exemplary embodiment, headphone 101 and microphone 102 are not integrated together. However, any form can be used if the form is capable of outputting sound information to user 11 and capturing the speech generated by user 11, e.g. an integral structure of headphone 101 and microphone 102.

In this exemplary embodiment, because of small holding capacity of navigator 110, server 104 is installed in another place and coupled thereto via communication lines. However, the system can be structured so that server 104 is also installed in navigator 110 and coupled thereto via electrical circuits. In this case, a part for extracting information on the routes to an object to be guided corresponds to an extractor of information on an object to be guided of the present invention.

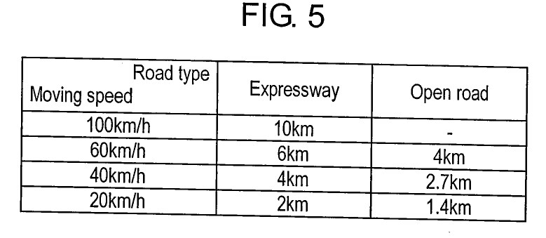

In this exemplary embodiment, a fixed value of 5 km is used as constant r in expression 1, because the constant is set according to the moving speed of the user. However, it is possible to use different distance r of 10 km or 15 km according to the type of the road the user is currently running, i.e. an expressway or open road. In this case, road information given by server 104 needs to include information on the road type. It is also possible to determine distance r, in consideration with the type of the road the user is currently running, as shown in FIG. 5. With this method, when the running speed is highly constant in an expressway, for example, distance r is set to a value larger than that of the case without consideration of the running speed. Thus, the user can understand changes in the distance to an object to be guided at a farther distance more clearly than those in an open road. Further, the shapes of roads, such as ups and downs or curves in the roads, can be taken into consideration when distance r is determined. The user can also set the distance to a fixed value. However, at that time, the value should be set within the range of several kilometers to several tens kilometers as described above.

In this exemplary embodiment, sound information generated by the user sets a destination in navigator 110. The destination can be set by another operation. The system can be structured so that transmitting text information on a destination from a terminal, such as a portable telephone, through communication using an infrared port sets a destination in navigator 110.

In this exemplary embodiment, when azimuth and distance calculator 107 calculates an azimuth, the moving histories of user 11 are used. However, the present invention is not limited to this example. A similar advantage can be obtained by using azimuth information that is obtained by adding information given by sensors, such as a gyro sensor and acceleration sensor, to information on a position given by a GPS.

In this exemplary embodiment, stereophony generator 108 uses a method disclosed in Japanese Patent Unexamined Publication No. 09-182199. However, the present invention is not limited to this method if any stereophony generating method capable of localizing a sound image in a specified position can be used.

This exemplary embodiment shows an example in which a user is driving a motorbike. However, the present invention is not limited to this example. A case where the user is moving on foot, by bicycle, or by car can provide the similar advantages.

This exemplary embodiment shows an example in which a user is moving to reach a destination. However, also applicable example is that an accompanying person, such as a child, has an identification tag for transmitting the position information thereof, and the relation between the positions of the accompanying person and the user is informed, using the position information transmitted from the identification tag as destination information. In this case, because the moving speeds of the means of transportation of the user, such as walking and a motor-driven cart, are considered relatively slow, the relation between the positions of the accompanying person and the user is divided into two equal parts on the right and left sides, when azimuth and distance calculator 107 calculates an azimuth. When the relation is on the right side, the azimuth is determined to be at 45 degrees in the front right direction. When the relation is on the left side, the azimuth is determined to be at 45 degrees in the front left direction. Similar advantages can be obtained when an azimuth is divided in steps in this manner.

When the present invention is implemented with a user moving on foot, it is also considered that the user moves, listening to the music by a music player, unlike driving a motorbike. Because a sound information output apparatus disclosed in this exemplary embodiment can supply sound in stereo, of course, the apparatus can also work as a portable sound playback unit. In this case, the sound volume of the music being played back is suppressed to a half the ordinary power volume, and guiding sound is superposed on the music for output. For the guiding sound, informing sound or speech for drawing attention is presented first, and thereafter the guiding sound is presented in stereo.

### Second Exemplary Embodiment

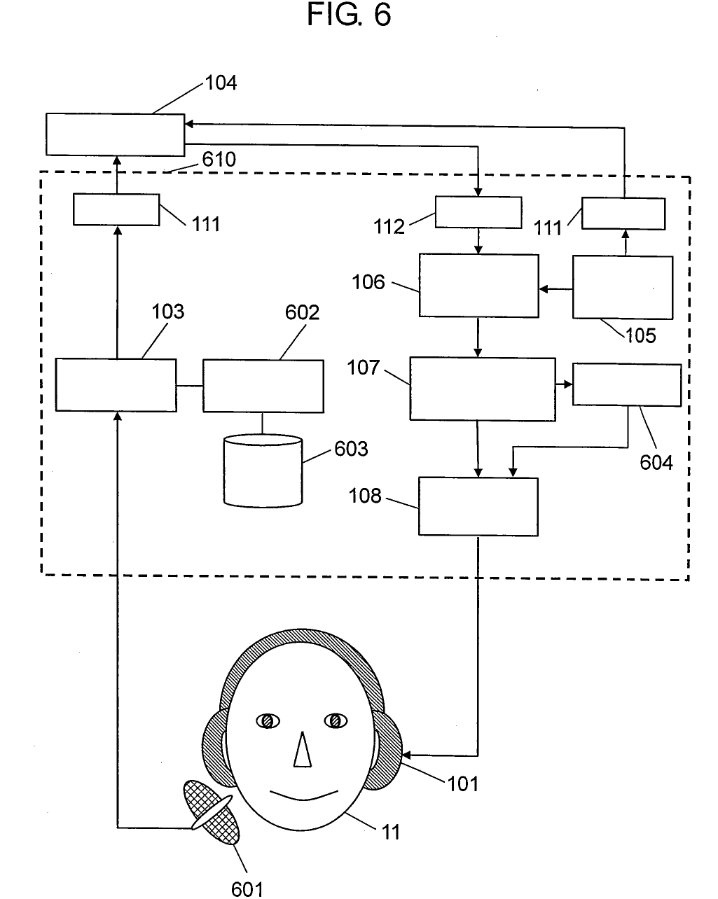

FIG. 6 is a block diagram illustrating a structure of a navigation system in accordance with the second exemplary embodiment of the present invention. Microphone 601 and navigator 610 of this navigation system are different from those of the first exemplary embodiment.

Microphone 601 of this exemplary embodiment has a function of simply capturing sound, and has no function of canceling noise, unlike microphone 102 of the first exemplary embodiment.

Further, navigator 610 of this embodiment includes input noise suppressor 602, acoustic model 603, and sound volume calculator 604 in addition to the components shown in the first exemplary embodiment.

This input noise suppressor 602 inhibits stationary noise, such as sound of a running vehicle, by subtracting the components corresponding to those of predetermined acoustic model 603, using spectral subtraction.

Sound volume calculator 604 calculates sound volume according to elevation angle θ calculated by azimuth and distance calculator 107.

Expression 3 is used to calculate the sound volume. F(θ) is a function of elevation angle θ. When elevation angle θ is π/2, f(θ) is 1.5. When elevation angle θ is other than π/2, f(θ) is 1.

Vol(θ)=f(θ)×Vol_{org} (Mathematical Expression 3)

The operation of navigator 610 structured as above is described hereinafter with reference to the accompanying drawings.

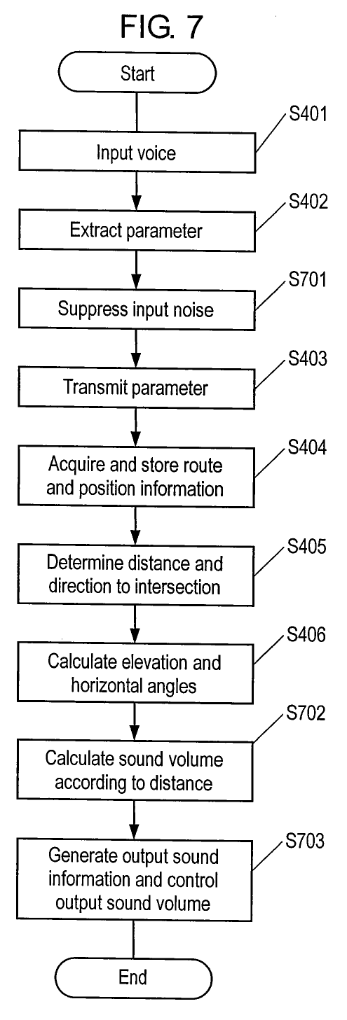

FIG. 7 is a flowchart showing the operation of the navigator, i.e. a sound information output apparatus of the present invention.

With reference to FIG. 7, first, speech processor 103 converts the speech data supplied by user 11 from microphone 601 into digital signals, and extracts parameters (LPC) to be used for speech recognition (steps S401 and 402).

Next, after input noise suppressor 602 suppresses noise in the parameters (LPC) using acoustic model 603 (step S701), speech processor 103 transmits the parameters (LPC) subjected to noise suppression to server 104, in a similar manner to the first exemplary embodiment (step S403).

Thereafter, storage for received information on an object to be guided 106 stores route information from server 104 and current position information from position information detector 105 (step S404), and azimuth and distance calculator 107 calculates azimuth data (elevation and horizontal angles) and distance data, based on the route and current position information (steps S405 and 406).

Next, sound volume calculator 604 calculates sound volume information based on the elevation angle calculated by azimuth and distance calculator 107, and informs stereophony generator 108 of the sound volume information, and azimuth and distance calculator 107 also informs stereophony generator 108 of the calculated azimuth data and distance data (step S702).

Upon reception of these data, stereophony generator 108 generates output sound information having a virtual sound image localized outside of the headphone in a manner similar to the first exemplary embodiment. At this time, stereophony generator 108 controls the sound volume of the output sound information, based on the sound volume information from sound volume calculator 604. Then, stereophony generator 108 converts the output sound information into analog sound signals for output to headphone 101 (step S703).

In this exemplary embodiment, spectral subtraction using an acoustic model is performed as a means of suppressing stationary noise. However, the present invention is not limited to this example. The stationary noise can also be suppressed by a filter for limiting bands of the input sound signals.

Additionally, this exemplary embodiment has no special means of alleviating noise in the sound supplied from the sound information output apparatus. However, an example that has a means of alleviating noise by subtracting components corresponding to those of a predetermined model is more useful for the user because the user can listen to sound information more easily. This means of alleviating noise can alleviate the influence of noise analogous to that of a predetermined acoustic model, such as whizzing and road noises of running vehicles, among the noises superposed on the output sound.

Further, in this exemplary embodiment, the sound volume varies with elevation angles. However, it is also effective to vary the sound quality with the elevation angles. In other words, the ordinary guiding sound is set to a lower female speech, and only when the elevation angle with respect to the virtual sound source is 90 degrees, the pitch of the speech is increased to provide a relatively higher female speech. This change exerts an auxiliary effect to improve recognizability of the user.

As described above, the present invention allows a user to understand the distance from the current position to an object to be guided more instinctively, because the user can recognize a change in the distance not only as a change in the elevation angle of the guiding sound with respect to the virtual sound source but also a difference in sound volume.

### INDUSTRIAL APPLICABILITY

The present invention is useful for a method and apparatus of outputting sound information that inform the user of the azimuth and distance to an object to be guided, using sound information. The present invention is suitable for a navigator, traffic information display unit, or other devices for use in a bicycle, motorbike, or minibike in which changing the driver's eye lines out of the front can cause danger.

1. A sound information output apparatus including:
an azimuth and distance information determination part for determining information on an azimuth and distance to an object to be guided to a user, based on information on a route to a position of the object and a moving direction calculated from information on a position of the user;
a vertical position determination part for determining a vertical position of a sound source, based on the information on the distance determined by the azimuth and distance information determination part; and
a stereophony output part for outputting a sound signal so that the sound source is virtually disposed in a place in which a horizontal position thereof is in front of the user and a vertical position thereof is determined by the vertical position determination part.

2. The sound information output apparatus of claim 1, wherein the horizontal position of the sound source is not limited to the front of the user, and is determined by a horizontal position determination part for determining the horizontal position of the sound source based on the azimuth information determined by the azimuth and distance information determination part.

3. The sound information output apparatus of claim 1, wherein the horizontal position of the sound source is not limited to the front of the user, and is determined by a horizontal position determination part that divides the azimuth into more than one section, replaces the azimuth information determined by the azimuth and distance determination part with a typical value of each section azimuth information belongs to, and determines the horizontal position of the sound source based on the typical values.

4. The sound information output apparatus of claim 2, wherein, when using the distance information to determine a vertical angle, the vertical position determination part distributes the distance from zero to a certain value from a vertical to horizontal angle perpendicular thereto, and sets the vertical angle to a horizontal or proximity to horizontal at a distance farther than a predetermined distance.

5. The sound information output apparatus of claim 4, wherein the predetermined distance is determined by using at least one of a moving speed of the user, information on a type of a road the user is running, a shape of a road the user has been running, and a value set by the user.

6. The sound information output apparatus of claim 1, including:
a speech data input part for receiving speech data; and
an extractor of information on an object to be guided for determining the object to be guided and extracting information on the route to the object, based on the speech data fed into the speech data input part.

7. The sound information output apparatus of claim 1, including:
a speech data input part for receiving speech data;
a transmitter for transmitting a sound related data fed into the speech data input part to another apparatus; and
a receiver for receiving information on the route to the object to be guided that has been extracted from the apparatus upon receipt of the sound related data transmitted by the transmitter.

8. The sound information output apparatus of claim 6, including:
an input noise suppressor for suppressing an influence of a predetermined noise among those fed into the speech data input part together with the speech data.

9. The sound information output apparatus of claim 7, including:
an input noise suppressor for suppressing an influence of a predetermined noise among those fed into the speech data input part together with the speech data.

10. The sound information output apparatus of claim 8, wherein the input noise suppressor performs one of spectral subtraction using a predetermined acoustic model or band control based on an acoustic frequency band.

11. The sound information output apparatus of claim 9, wherein the input noise suppressor performs one of spectral subtraction using a predetermined acoustic model or band control based on an acoustic frequency band.

12. A sound information output method including:
determining information on an azimuth and distance to an object to be guided to a user, based on information on a route to the object, and a moving direction calculated from information on a position of the user;
determining a vertical position of a sound source based on the information on the distance determined by the azimuth and distance determining step; and
outputting stereophony by outputting a sound signal so that the sound source is virtually disposed at a place in which a horizontal position thereof is in front of the user and a vertical position thereof is as determined by the vertical position determining step.

13. The method of outputting sound information of claim 12, wherein the horizontal position of the sound source is not limited to the front of the user, and is determined by the azimuth information determined by the azimuth and distance information determining step.
